(19) United States
(12) Patent Application Publication
(10) Pub. No.: US 2016/0314405 A1
(43) Pub. Date: Oct. 27, 2016

(54) METHOD OF MAINTENANCE OF EQUIPMENT

(71) Applicants: THALES, Courbevoie (FR); INSTITUT NATIONAL DE RECHERCHE EN INFORMATIQUE ET EN AUTOMATIQUE, Le Chesnay (FR)

(72) Inventors: Didier BIHANNIC, ELANCOURT (FR); Camille BAYSSE, ELANCOURT (FR); Benoîte DE SAPORTA, TALENCE (FR); François DUFOUR, TALENCE (FR); Anne GEGOUT-PETIT, TALENCE (FR); Jérôme SARACCO, TALENCE (FR)

(21) Appl. No.: 15/104,945

(22) PCT Filed: Dec. 18, 2014
(86) PCT No.: PCT/EP2014/078399

§ 371 Date: Jun. 15, 2016

(30) Foreign Application Priority Data
Dec. 20, 2013 (FR) 1303026

(51) Int. Cl. G06N 7/00; G06Q 10/00

(52) U.S. Cl. CPC G06N 7/005; G06Q 10/20

(57) ABSTRACT

The invention relates to a method for maintaining equipment likely to go through at least a degraded state before failing, this equipment being provided with a data sensor, linked to a recorder, which is in turn associated with a processing unit, which comprises the following steps of: detection of states of the equipment from the recorded data, and by means of a hidden Markov model, determination of an optimal maintenance date as a function of a state of the equipment, of a predetermined aggregate usage time of the equipment, by using an optimal stop on PDMP, which comprises: a substep of calculation of a quantization grid made up of cells with, for each cell, the transition date, the state of the equipment on that transition date, the time spent in the preceding state, the probability of being in said state on said date, a substep of calculation of a discretized grid of remaining usage time for each cell of the quantization grid, a substep of calculation of the maintenance date starting from a state of the equipment detected on a date t and from the date of transition into this state which is itself determined as a function of the usage time, and by using the discretized quantization grid. The so-called optimal maintenance date is determined by minimizing the mathematical expectation of an hourly cost function; there is also associated with each cell of the discretized quantization grid a probability of going from the state of said cell to each other possible state.

The field of the invention is that of the maintenance of equipment likely to go through a degraded state before failing.

The users of such equipment experience failures in operation which generate:
mission failures,
significant repair costs,
losses of client trust in our products,
degradation of the brand image and difficulties in obtaining new contracts,
stress among users provoked by the fear of failure.

While it is difficult, even impossible, to avoid failures, it is possible to control some of them. Controlling failure conventionally consists in:
detecting the degraded state preceding the failure (diagnostic),
indicating a predictive failure date (prognostic).

Controllable failures are failures of wear and fatigue. They are present on mechanical, hydraulic and other such members. Hereinafter, a tire or a piece of optronics equipment will be taken as equipment examples.

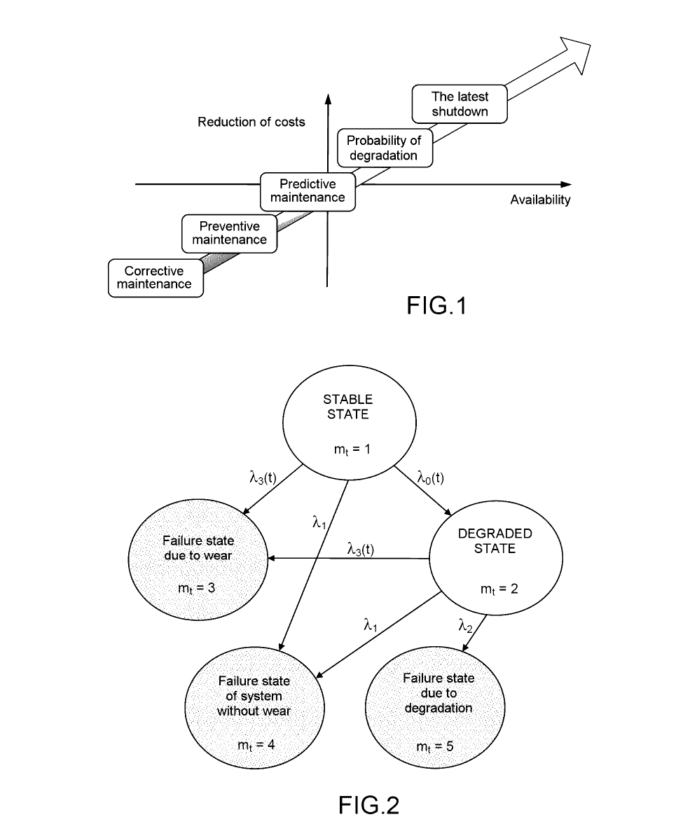

Different solutions illustrated in FIG. 1 have been implemented over time to determine an estimated maintenance date.

Corrective maintenance consists in repairing the equipment after the failure has occurred, which is not truly optimal.

Preventive maintenance consists in determining a fixed schedule regardless of the equipment. It will, for example, be recommended to check, even change, tires every 20 000 km.

Predictive maintenance consists in initiating the maintenance when a predetermined threshold is reached, such as a physical threshold of wear. When, for example, the tire pressure is too low, it is recommended to reinflate it to avoid removing the tire from the rim and having to change it, which may occur well before these 20 000 km for a sportively driven tire and well after for a calmly driven tire.

A maintenance date can be calculated as a function of a probability of degradation. This calculation, described notably in the publication “Optimisation de la maintenance d'un équipement optronique”, Camille Baysse et al., Congrès de Maîtrise des Risques et Sûgeté de Fonctionnement 16-18 Oct. 2012, is performed as a function of the estimated state of the equipment at a given instant, of the history of these states and of a performance level sought. Optronics equipment for example has a logbook which provides the following information on each startup: the number of uses, the aggregate operating time of the equipment, its initial temperature and the cooling time denoted Tmf. This cooling time is the time it takes for the equipment to go from an initial temperature (generally ambient temperature) to a very low temperature necessary to the correct operation of the equipment. Careful observation of the variable Tmf(t) which in fact reflects the state of the equipment at the instant t, makes it possible to detect as early as possible a change of state of the equipment and to propose a maintenance action whose main objective is to avoid failure. The problem is broken down into two steps: detection of the state of the equipment, determination of the maintenance policy.

The 1^{st} step uses a hidden Markov chain.

The 2^{nd} step aims to make it possible to anticipate all the failures, that is to say the failures linked to wear and the random failures (=not linked to wear) and to propose a maintenance action before they occur. The process is modeled by a piecewise deterministic Markov process, or “PDMP”, which takes account of the transition to the failure state from the stable state and from the degraded state. Optimal stop techniques are used and adapted to this process to maximize a performance function which takes account of the time spent in operation, of the maintenance, repair and downtime costs.

The preceding method can be refined as described in the publication “Maintenance optimisation of optronic equipment”, Camille Baysse et al., Chemical Engineering Transactions, Vol. 33, 2013. The determination of the maintenance date rests on the principle whereby the later the date is, the better that will be in terms of performance. According to this method, two steps are also implemented: detection of the state of the equipment as in the preceding case, determination of the maintenance policy.

The step of determination of the maintenance policy consists notably in calculating the maximum mathematical expectation of a performance function, starting from a state detected on a date t and from the date of transition into this state which is itself determined as a function of the usage time.

However, this method presents the following drawbacks:

it has been observed that the duly determined maintenance date may be too late inasmuch as the failure occurs before this date;

furthermore, it does not make it possible to determine the date on which it is most advantageous to perform maintenance from an economic point of view, for example or for safety.

In other words, maintenance performed too early may be unnecessarily costly because it may lead to the replacement of equipment in a good state of operation, and a nuisance for the user, but maintenance deferred too long may lead to the total failure of the equipment which is also not desirable.

The aim of the invention is to mitigate these drawbacks. Consequently, there remains, to this date, a need for a method for maintaining equipment whose main objective is, of course, to avoid the failure of the equipment by providing an optimal maintenance date (neither too early nor too late), as well as running the risk of failure.

More specifically, the subject of the invention is a method for maintaining equipment likely to go through at least a degraded state before failing, this equipment being provided with a data sensor, linked to a recorder of these collected data, which is itself associated with a processing unit, which comprises the following steps of:

detection of states of the equipment from the recorded data, and by means of a hidden Markov model,

determination of an optimal maintenance date as a function of a state of the equipment, of a predetermined aggregate usage time of the equipment, by using an optimal stop on PDMP, which comprises:
a substep of calculation of a quantization grid made up of cells with, for each cell, the date of transition, the state of the equipment on that date of transition, the time spent in the preceding state, the probability of being in said state on said date,
a substep of calculation of a discretized grid of usage time remaining for each cell of the quantization grid,
a substep of calculation of the maintenance date starting from a state of the equipment detected on a date t and from the date of transition into this state which is itself determined as a function of the usage time, and by using the discretized quantization grid.

It is mainly characterized in that the so-called optimal maintenance date is determined by minimizing the mathematical expectation of an hourly cost function and in that there is also associated with each cell of the discretized quantization grid a probability of going from the state of said cell to each other possible state.

According to a feature of the invention, it also comprises a step for determining, as a function of the discretized quantization grid, a probability of failing between a date t1 and a date t2 that are predetermined, calculated at an instant t with:

t1≦optimal maintenance date≦t2.

This method makes it possible to develop a decision aid tool which calculates the optimal date, the latter being able to be before, during or after the mission and which thus makes it possible to determine the risk that is run in using equipment on a given mission.

Other features and advantages of the invention will become apparent on reading the following detailed description, given as a nonlimiting example and with reference to the attached drawings in which:

FIG. 1, already described, illustrates the trend of the maintenance methods of the prior art,

FIG. 2 schematically represents an exemplary model of operation of a piece of equipment,

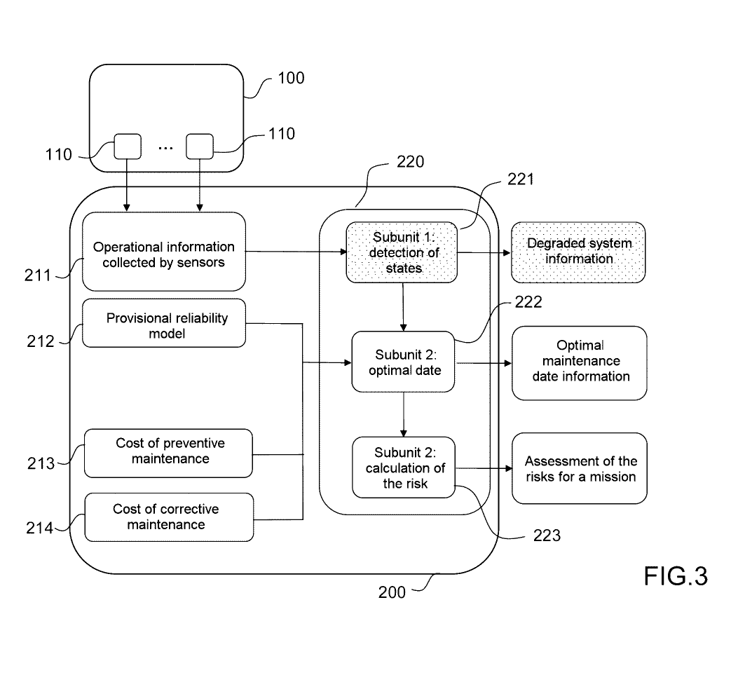

FIG. 3 schematically represents an example of functions implemented to perform the maintenance method according to the invention.

The invention will now be described by taking into account the example of equipment that can be in five states shown in FIG. 2:
stable state graded mₜ=1,
degraded state graded mₜ=2,
failure state due to wear graded mₜ=3,
failure state without wear (of exponential type) graded mₜ=4,
failure state due to degradation graded mₜ=5,
   t being the aggregate usage time.

The possible transitions between states are represented by the arrows. Also, for each transition, the probability of going from the original state to the other state is indicated and also designated transition rate or failure rate, some transition rates λ₀(t), λ₃(t) depending on the aggregate usage time t of the equipment, others λ₁, λ₂ being independent of this usage time (not therefore dependent on wear).

The probability of the equipment being in one of these five states=1.

The failure states are called absorbing states which means that the equipment cannot leave these states.

This information is hosted in a reliability model.

As illustrated in FIG. 3, the proposed solution consists in combining 2 types of data:
Operational, collected by one or more sensors 110 capable of collecting data specific to the equipment 100, and stored in a file 211.
Predetermined and stored in files 212-214: these are typically predictive data from analyses of reliability and of the maintenance/operating costs.

These data are linked as input to a processing unit 220 which comprises three subunits.

A first subunit 221 for detecting states of the equipment makes it possible, from the operational data, to determine the probability that the equipment is in a degraded state, by detecting a break in the behavior of a physical variable representative of the state of health of the equipment. It therefore involves:
estimating, at each instant, the state of the equipment measured by the probability that it is in a certain state knowing the history of the representative variable up to that instant,
detecting, as early as possible, this change of state of the equipment.

The mathematical modeling of this detection of degraded states relies on a hidden Markov chains model.

Consider Xₜ, t≧0 a continuous-time Markov chain, of state space with the vectors e₁=(1;0) and e₂=(0;1). Xₜ=e₁ when the state of the equipment is stable and Xₜ=e₂ when it is degraded at the instant t. Note that Xₜ=eₘₜ.

The state, which is not in fact observed directly, is observed through a physical variable representative of the equipment evolving in time and denoted Yt, which is a noisy function of this chain. In the example of the tire, it can be, for example, wear or pressure. For optronic equipment, Yt=Tmf(t) for example applies.

The following applies:

$${Y}_{t} = {\int }_{0}^{t} c ( {X}_{r} ) d r + {W}_{t}$$

with Wₜ a brownian noise independent of Xₜ and c(Xₜ) represents the slope of the degradation such as, for example, the rate of wear of the tire. The object is to calculate the probability that the equipment is in a given state at t knowing how Yₜ evolves up to the date t.

The next step consists in finding the optimal maintenance policy which makes it possible to achieve a compromise between maintenance that is too early or too late, both being too costly.

A second subunit 222 proposes, according to the invention, an optimal and dynamic maintenance date from the results supplied by the first subunit 221, that is to say from the state of the equipment, therefore from the data collected by the sensor or sensors and also from a reliability model 212. This date is
optimal because it minimizes the mathematical expectation of an hourly cost function g,
dynamic because it depends on the state of the equipment mₜ.

The hourly cost g(mₜ,t) depends on the time t spent in operation (=aggregate usage time), on the state mₜ of the equipment at t, and on the maintenance, repair and downtime costs derived from cost of preventive maintenance and cost of corrective maintenance information. The calculation takes account of the time spent in a state and not only the state at a given instant.

The calculation of this maintenance date is based on a modeling of the state of the equipment by a PDMP process. In effect, these PDMPs make it possible to model physical models with a dynamic that can be disturbed by one-off and random events. In this case, that makes it possible to take account of the possible transition from the stable state (mₜ=1 in our example) to the failure state directly because of a random cause (mₜ=4) or indirectly by going through the degraded state (mₜ=2).

It will be recalled that a PDMP is a hybrid process with two components denoted fit. The hybrid process which describes the state of operation and the age t of the equipment (=aggregate usage time) is expressed ζₜ=(mₜ,t).

The dynamic and optimal maintenance date is determined by minimizing the mathematical expectation of an hourly cost function g(mₜ,t), which amounts to solving an optimal stop problem. That is equivalent to minimizing to the random instant T the equation Eζ₀[g(m_{T}, T)], E being the mathematical expectation, knowing that the random instant T which minimizes this expectation is this dynamic and optimal maintenance date. This approach, which is differentiated from that adopted in the prior art recalled in the preamble, does not devolve therefrom in an obvious manner because E(1/F)≠1/E(F) where E represents the expectation and F a random variable.

The calculation of this maintenance date is performed in a number of steps:
On startup, a predetermined initial optimal date T₀ is considered, stored for example in the reliability model 212; it is for example the first maintenance date proposed by the manufacturer of the equipment.
Quantization: the transition rates between the states of the system (hosted in the reliability model) are used to simulate a predetermined large number N of trajectories (=possible histories for the equipment) and to quantize the Markov chains associated with the PDMP (transition time, state at the transition time). A quantization grid is obtained with 3 dimensions: the first axis represents the transition date, the second axis, the state of the system on that date and the third axis, the time spent in the state preceding this transition. A quantization technique is described, for example, in the works by G. Pagès, notably in the publication “G. Pagès, A space quantization method for numerical integration, Journal of computational and applied mathematics 89 1-38, 1997”.
The quantization grid is made up of cells; a cell comprises the transition date (Tₙ), the state at the time of transition (m_{Tn}) and the time spent in the preceding state (Sₙ=Tₙ−Tₙ₋₁). The probability of being in said state on this transition date (P(m_{Tn}, Tn)) is associated with this cell. For this equipment with 5 states for example, the following are obtained as cells of the quantization grid:
(t₀, 1, S₁, P(1, t0))
(t₁₂, 2, S₂, P(2, t₁₂)), t₁₂ being the date of transition from the state 1 to the state 2,
(t₁₃, 3, S₃, P(3, t₁₃)), t₁₃ being the date of transition from the state 1 to the state 3,
(t₂₃, 3, other S₃, P(3, t₂₃)), t₂₃ being the date of transition from the state 2 to the state 3,
(t₁₄, 4, S₄, P(4, t₁₄)), t₁₄ being the date of transition from the state 1 to the state 4,
(t₂₄, 4, other S₄, P(4, t₂₄)), t₂₄ being the date of transition from the state 2 to the state 4,
(t₂₅, 5, S₅, P(5, t₂₅)), t₂₅ being the date of transition from the state 2 to the state 5.

Typically it is possible to simulate 100 000 histories (N=100 000), that is to say consider, for each transition from one state to another, different durations S. There can be for example (t₁₃, 3, duration1, P(3, t₁₃)), (t₁₃, 3, duration2, P(3, t₁₃)) and (t₁₃, 3, duration3, P(3, t₁₃)), (t₁₃, 3, duration4, P(3, t₁₃)), etc.

Discretization: with each cell of this quantization grid there is associated a discretized time grid, which necessitates, for each cell, considering the remaining duration of use. If for example the aggregate usage time of the equipment is 25 000 h, then, for a cell for which the date of transition from the state i to the state j is denoted tᵢⱼ, the remaining duration of use is equal to:

25 000 h−tᵢⱼ.

This duration is then itself discretized, the set of these discretized durations forming, for this cell, the discretized usage time grid.

Then, this time-discretized quantization grid is used to calculate the function g(mₜ,t) and the minimum hourly cost function (min Eζ₀[g(m_{T}, T)]) and the associated maintenance date policy are deduced according to the history of the process.

Furthermore, each cell of the discretized quantization grid has associated with it the probability P of going from the state of the cell to each other possible state, by using the transition rates derived from the predictive reliability model. By using the preceding example, the following is obtained:
(t=0, 1, S₁, P(1, t0), P₁₂, P₁₃, P₁₄)
(t₁₂, 2, S₂, P(2, t₁₂), P₂₃, P₂₄, P₂₅),
(t₁₃, 3, S₃, P(3, t₁₃)),
(t₂₃, 3, other S₃, P(3, t₂₃)),
(t₁₄, 4, S₄, P(4, t₁₄)),
(t₂₄, 4, other S₄, P(4, t₂₄)),
(t₂₅, 5, S₅, P(5, t₂₅)).

No probability of changing state is associated with the states 3, 4 and 5 because they are absorbing states.

With this discretized quantization grid having been determined for example by the manufacturer of the equipment, as well as the optimal and dynamic date T, they (grid and date T) are then used by the user of the equipment to help determine, at each instant, the risk of failure of the mission using said equipment. This is done by a subunit 3 by projecting onto this grid the data from the equipment at a predetermined instant, to obtain the associated optimal maintenance date. In effect, if the optimal maintenance date T falls during a mission defined by its start t1 and end t2 dates (→T between t1 and t2), the calculation of the probability of failure of the mission associated with the hourly cost of the equipment during the mission (at the start, at the end of the mission and on the optimal date), may urge the user of the equipment to decide to perform a maintenance procedure before or after the mission.

The procedure is as follows. These equipment histories are once again simulated and they are quantized by projecting them onto the preceding discretized quantization grid. With each cell of the grid, it is possible to associate the probability of the cell and of its transition to another cell as well as a time grid. All these elements will make it possible to calculate, for each cell, the minimum of the mathematical expectation of the hourly cost function as well as the date which minimizes it. This date will then be the maintenance date for the equipment whose history is projected (quantized) on this cell.

On startup, the user defines a maintenance date T common to all the equipment, because all such equipment items are in the stable state at the time t=0 (same history). They are therefore projected onto the same cell. This cell therefore returns a maintenance date T.

If the system changes state at the time T1<T, this maintenance date is revised on the basis of the result supplied by the discretized quantization grid for the state at T1, otherwise the maintenance is carried out on the date T.

The probability of a failure (also called calculation of the risk of failure) between two times t1 and t2 predetermined by the user is then calculated at the time t by carrying out the following steps (often t1<T≦t2):
use of the quantization grid to calculate the ratio: (sum of the weights of the cells in failure state at t2 minus the sum of the weights of the cells in failure state at t1) to (sum of the weights of the cells in running state at t),
calculation of the probability at the instant t of overall failure during a mission which is equal to the calculated ratio, or
for each type of state, calculation of the probability of state transition during a mission.

For example, the probability of transition from mₜ=1 to mₜ=2 during a mission is given by the sum of the weights of the cells for which the instant of first transition into the state mₜ=2 lies between t1 and t2.

The probability of transition from the state mₜ=1 to the failure state during a mission is given by the sum of the weights of the cells for which the instant of first transition into the failure state lies between t1 and t2.

The probability of transition from the state mₜ=2 to the failure state during a mission is given by the ratio: (sum of the weights of the cells for which the second transition (into the failure state) lies between t1 and t2) to (the sum of the weights of the cells in the state mₜ=2 at t1).

This maintenance method can notably be implemented using a computer program product, this computer program comprising code instructions making it possible to perform the steps of the processing subunits 1, 2 and 3. It is stored on a computer-readable medium, such as, for example, the computer 200 linked to the sensors 110 of the equipment 100 and in which are stored the files of the operational information 211, of the reliability model 212, and of the costs of preventive 213 and corrective 214 maintenance. The medium can be electronic, magnetic, optical, electromagnetic or be a broadcast medium of infrared type. Such media are, for example, semiconductor memories (Random Access Memory RAM, Read-Only Memory ROM), tapes, diskettes or magnetic or optical disks (Compact Disc-Read Only Memory (CD-ROM), Compact Disc-Read/Write (CD-R/W) and DVD).

1. A method for maintaining equipment likely to go through at least a degraded state before failing, this equipment being provided with a data sensor, linked to a recorder of these collected data, which is itself associated with a processing unit, which comprises the following steps of:
detection of states of the equipment from the recorded data, and by means of a hidden Markov model,
determination of an optimal maintenance date as a function of a state of the equipment, of a predetermined aggregate usage time of the equipment, by using an optimal stop on PDMP, which comprises:
a substep of calculation of a quantization grid made up of cells with, for each cell, the date of transition, the state of the equipment on that date of transition, the time spent in the preceding state, the probability of being in said state on said date,
a substep of calculation of a discretized grid of usage time remaining for each cell of the quantization grid,
a substep of calculation of the maintenance date starting from a state of the equipment detected on a date t and from the date of transition into this state which is itself determined as a function of the usage time, and by using the discretized quantization grid,
wherein the so-called optimal maintenance date is determined by minimizing the mathematical expectation of an hourly cost function and wherein there is also associated with each cell of the discretized quantization grid a probability of going from the state of said cell to each other possible state.

2. The method for maintaining equipment as claimed claim 1, comprising a step for determining, as a function of the discretized quantization grid, a probability of failing between a date t1 and a date t2 that are predetermined, calculated on the date t, with:
t≦t1<optimal maintenance date≦t2.

3. The method for maintaining equipment as claimed in claim 1, wherein the equipment has five states which are stable state, degraded state, state of failure due to wear, state of failure without wear, state of failure due to degradation.

4. The method for maintaining equipment as claimed in claim 1, wherein the equipment is optronic.

5. A computer program product, said computer program comprising code instructions making it possible to perform the steps of the method for maintaining equipment as claimed in claim 1, when said program is run on a computer.
